(19) United States
(12) Patent Application Publication
(10) Pub. No.: US 2024/0246642 A1
(43) Pub. Date: Jul. 25, 2024

(54) SUPPORTING ARRANGEMENT FOR A CARRIED LOAD, MORE PARTICULARLY A LOAD CARRIED ON A SHIP

(71) Applicant: 3J MARINE S.R.L., Roma (RM) (IT)

(72) Inventors: Andrea ALFANO, Angri (SA) (IT); Giancarlo RAIOLA, Angri (SA) (IT)

(21) Appl. No.: 18/561,376

(22) PCT Filed: May 19, 2022
(86) PCT No.: PCT/IB2022/054680

§ 371 Date: Nov. 16, 2023

(30) Foreign Application Priority Data
May 24, 2021 (IT) 102021000013337

(51) Int. Cl. B63B 25/28; B60P 7/13; B60P 7/18

(52) U.S. Cl. CPC B63B 25/28; B60P 7/132; B60P 7/18; B63B 2025/285

(57) ABSTRACT

A supporting arrangement for a carried load, more particularly a load carried on a ship such as, for example, a container, is provided. The supporting arrangement provides for connecting, in a non-rigid manner, the carried load to a bearing structure integral with the ship and to this aim it comprises a plurality of movement dampers interposed between the carried load and the bearing structure. The dampers can be directly interposed between the load and the bearing structure; alternatively, the supporting arrangement further comprises a supporting frame and the movement dampers are applied to the supporting frame. Owing to the fact that the carried load is not rigidly connected to the structure of the ship, the movements to which the ship is subjected during sea travel, especially because of wave movement, are not transmitted to the carried load, which therefore does not risk falling overboard.

### TECHNICAL FIELD

The present invention relates to a supporting arrangement for a carried load, more particularly a load carried on a deck or other bearing structure of a ship.

The present invention finds particular application in the transportation of containers arranged in superimposed stacks, especially on a deck or other bearing structure of a ship.

More particularly, the present invention relates to a supporting arrangement that is intended for containers or other loads carried on a deck or other bearing structure of a ship and allows improved contact between the containers and said deck/bearing structure.

### BACKGROUND ART

Container ships for carrying goods by sea are known.

Maritime transportation is often a stage of a larger intermodal transport process, in which goods may be moved from one means of transport (trucks, trains, ships, etc.) to another to get from a starting site to a shipping site.

For this purpose, goods are organized into standardized cargo units, the most common of which are containers.

In this regard, since 1966, in order to standardize the characteristics of containers to ensure their compatibility on all means of transport and also in the case of international trade, standards have been established under the auspices of ISO for the regulation of shape, size, and structural characteristics of said containers.

Concerning size, the base unit according to the ISO standards is the so-called “40-foot container 40” (12,192 m). From this come 10-foot (2.991 m), 20-foot (6.058 m) and 30-foot (9.125 m) containers.

Advantageously, the adoption of these standardized sizes allows containers to be transported in multiple stacks side by side. Typically, such stacks consist of six stacked containers, although newer solutions allow the number of stacked containers to be further increased to nine or ten.

From a constructional point of view, the load-bearing element of each container is a frame, usually made of steel and consisting of four corner posts connected to each other at the bottom and top by longitudinal and transverse beams: said bearing frame is in itself capable of ensuring the stability and load-bearing capacity of the container.

At the points where the corner posts connect to the lower and upper longitudinal and transverse beams, containers are provided with corner blocks. Said corner blocks enable the connection of containers to the bearing structure of a means of transport, as well as the connection of containers to each other in case of transport of stacked containers. In addition, said corner blocks ensure that containers can be moved from one means of transport to another.

In general, corner blocks are provided, on their three outer faces, with connecting means, suitable for cooperation with corresponding connecting means of a supporting structure of a means of transport, or an adjacent container, or even a crane or other handling equipment.

The most common connection means for connecting containers to the supporting structure of a transport vehicle are so-called “twist-locks” (i.e. twist closures).

“Twist-lock” connections comprise a female connection element (generally provided on the container) that has no moving parts and is provided with an oval hole on its lower face, and a male connection element (generally provided on the bearing structure) that has on top a cam-profile component rotatable with respect to a fixed base: the cam-profile component of the male connection element is inserted into the oval hole of the female connection element, and then rotated by 90° so that it can no longer come out of the female connection element. Rotation of the cam-profile component can be carried out either by a specially provided lever on the male connection element, or by a separate tool.

In the specific case of maritime transportation, containers can be arranged either below deck or over deck.

With regard, in particular, to containers carried above deck, the lowermost row of containers will be connected to the deck or other bearing structure fixed to the hull structure at the lower corner blocks, for example, by means of “twist-lock” connections. Subsequently, additional rows of containers will be stacked on top of said lowermost row, again taking advantage of the corner blocks to connect the containers to each other.

However, this solution has often proved unsatisfactory.

Indeed, there are frequent cases where connections between containers or to the bearing structure of the ship fail and containers fall overboard.

Such accidents also occur in the case of other types of cargoes carried on ships.

It is clear that falling of cargoes into the sea constitutes a serious damage, both economically and ecologically, if they cannot be recovered.

An object of the present invention is therefore to overcome the prior art problem set forth above, by providing a supporting arrangement intended for supporting a carried load, such as, for example, a container, and allowing improved connection between containers and structures of the ship itself.

This and other objects are achieved with the supporting arrangement as claimed in the appended claims.

### SUMMARY OF INVENTION

The Applicant has found that the above-mentioned problems are mainly due to the fact that according to prior art the containers or other cargoes are rigidly attached to the structure of the ship.

For example, as anticipated above, containers are stacked on multiple levels, and the lowermost row of containers is connected to the deck of the ship or to a dedicated bearing structure integral to the ship structure.

In both cases, the containers in the lowermost row are connected to said deck or bearing structure in a rigid manner.

It follows that the movements made by the ship, and in particular those movements of the ship caused by wave movement, are transmitted to the container stacks.

Such movements cause the container stacks to become unbalanced, this resulting in the release of the means of connecting said containers to each other and to the ship structure, whereby the containers fall overboard.

In the light of the above, the supporting arrangement according to the invention provides for connecting in a non-rigid manner the carried load to a supporting structure integral to the vessel. Said bearing structure integral with the ship may be a dedicated bearing structure or the ship deck itself.

For example, in the case of containers, the supporting arrangement according to the invention provides for connecting in a non-rigid manner the lowermost row of containers to a bearing structure integral with the ship.

In order to connect said load to said bearing structure in a non-rigid manner, the invention provides for interposing a plurality of movement dampers between said load and said bearing structure.

The provision of said movement dampers makes it possible, in particular, to prevent movements to which the ship is subjected (including rolling, pitching and jerking) from being transmitted to the carried load or in any case to drastically limit the transmission of such movements to said load.

In a first preferred embodiment of the invention, the supporting arrangement according to the invention comprises a supporting frame and a plurality of movement dampers arranged between said supporting frame and said bearing structure integral with the ship.

Therefore, the upper portion of said movement dampers will be connected to the lower face of the supporting frame, whereas the lower portion of said movement dampers will be provided with means for connection to the underlying bearing structure.

Advantageously, it will be possible to take advantage of the predisposition of said bearing structure to receive the load and it will therefore be possible to provide the movement dampers with connecting means configured so as to be able to cooperate with the connecting means conventionally provided on the bearing structure for load mounting.

The upper face of the supporting frame will instead be provided with connecting means for mounting the load thereto, i.e. it will be provided with connecting means configured so as to be able to cooperate with the connecting means conventionally provided on the load (for example, male “twist-lock” connection elements).

Advantageously, it will therefore be possible to integrate into a same component, i.e. the movement damper of the present invention, the function of connection between the load and the bearing structure and the function of damping the transmission of movements.

This makes it possible, on one part, to limit the number of components and simplify the mounting of carried loads to the bearing structure, and, on the other part, to integrate the movement dampers of the present invention into existing structures, without the need for structural changes.

In a second preferred embodiment of the invention, the supporting arrangement according to the invention comprises a plurality of movement dampers directly interposed between the load (for example, the containers of the lowermost row) and the bearing structure integral with the ship.

Therefore, the upper portion of each movement damper will be connected to the load (for example, in the case of containers, to the corner block of a corresponding container), whereas the lower portion of the movement damper will be provided with connecting means for connection to the underlying bearing structure.

In this case, too, it will be possible to take advantage of the predisposition of said bearing structure to receive the load and it will therefore be possible to provide the movement dampers with connecting means configured so as to be able to cooperate with the connecting means conventionally provided on the bearing structure for load mounting.

In this second embodiment, each movement damper will be provided, in its upper portion, with connecting means for mounting a load (for example, a container) thereto, i.e. it will be provided with connecting means configured so as to be able to cooperate with the connecting means conventionally provided on the load (for example, male “twist-lock” connection elements). Therefore, even in this second embodiment, the movement dampers will perform both the function of connection between the load and the bearing structure and the function of damping the transmission of movements, which will result in a simplification of the mounting of carried loads to the bearing structure and allow the integration of movement dampers of the present invention into existing structures, without the need for structural changes.

It will be evident to the person skilled in the art that the supporting arrangement according to the invention, in either of the embodiments outlined above, can be advantageously implemented on existing ships without the need to introduce substantial structural changes.

In a preferred embodiment of the invention, each movement damper comprises two different types of components, and in particular a first, load-bearing component, adapted to bear the vertical loads generated by overlying loads (as well as by the supporting frame, where provided), and a second, damping component, adapted to interrupt—or at least significantly limit—the transmission of movement from the bearing structure integral with the ship to the carried load.

In a preferred embodiment of the invention, the load-bearing component is made as a body made of a substantially rigid material.

In a preferred embodiment of the invention, the load-bearing component is made as a ball made of a substantially rigid material.

In a particularly simple embodiment of the invention, the load-bearing component is made as a plate arranged around the load-bearing component and shaped so as to comprise a concave or convex portion, the concavity/convexity being oriented in a direction substantially perpendicular to the direction of load application.

For example, the damping component can be made as a “C”-shaped plate arranged around the load-bearing component. However, other shapes are possible, such as, for example, an “S”-shaped plate, an “X”-shaped plate, and so on.

In this embodiment, in order to damp the load with respect to movements oriented in different directions, it is preferable to provide a plurality of movement dampers with damping components oriented differently. For example, it is possible to provide four groups of movement dampers, each of which is mounted, relative to the bearing structure integral with the ship, with its “C”-shaped plate offset by 90° with respect to the other groups.

In a more complex embodiment of the invention, the damping component is made as a plurality of plates shaped so as to have each a concave or convex portion and oriented differently and arranged around a same load-bearing component.

For example, it is possible to provide a damping component comprising four “C”-shaped plates offset by 90° relative to one another. However, it is also possible to provide a different number of plates and/or plates with different concave or convex shape.

### BRIEF DESCRIPTION OF DRAWINGS

Features and advantages of the present invention will become more apparent from the detailed description of some preferred embodiments of the invention, given by way of non-limiting examples with reference to the annexed drawings, in which:

FIG. 1 shows a supporting arrangement according to a first embodiment of the invention, and a container applied thereto;

FIG. 2 shows in enlarged scale the detail I of FIG. 1;

FIG. 3 shows in a further enlarged scale the detail II of FIG. 2, in which the contained has been removed;

FIG. 4 shows a supporting arrangement according to a second embodiment of the invention, and a container applied thereto;

FIG. 5 shows in enlarged scale a movement damper of the supporting arrangement of FIG. 4.

### DESCRIPTION OF EMBODIMENTS

In the ensuing detailed description of preferred embodiments of the invention, reference will be made to the specific application of container transportation. However, it will be evident to the person skilled in the art that the invention can equally be applied to the transportation of other loads.

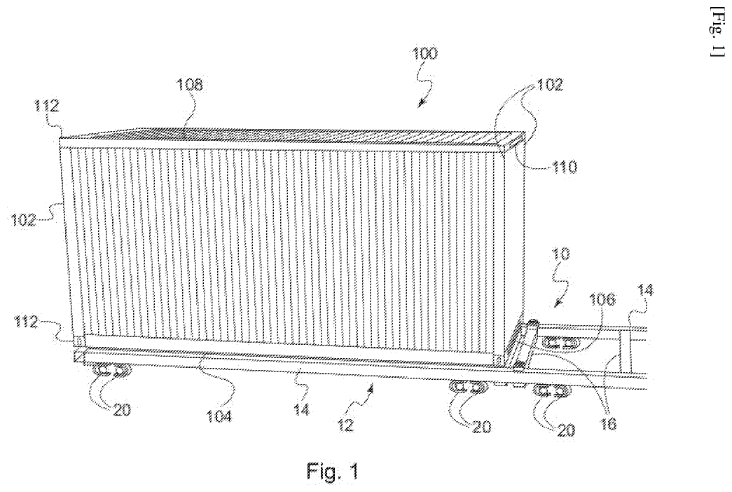

Referring at first to FIGS. 1-3, there is shown a first embodiment of a supporting arrangement 10 for containers 100 according to the invention.

As can be seen in FIG. 1, according to prior art a container 100 comprises a frame, usually made of steel and consisting of four corner posts 102 connected to each other at the bottom by lower longitudinal 104 and lower transverse beams 106 and on top by upper longitudinal beams 108 and upper transverse beams 110. At the points where the corner posts 102 connect to the lower and upper longitudinal and transverse beams 104-110, the container is provided with corner blocks 112 bearing connecting means for connection to outer structures and/or other containers.

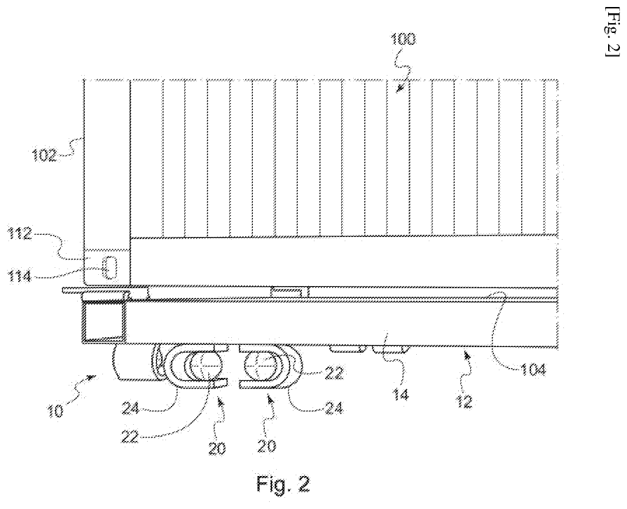

As better visible in FIG. 2, at the point where a corner post 102 connects with a lower longitudinal beam 104 and a lower transverse beam 106, there is provided a corner block 112 bearing a female “twist-lock” connection element 114.

According to the invention, the container 100 is not directly connected to a bearing structure integral with the structure of a ship (not shown), and it is, instead, connected to said bearing structure with interposition of a supporting arrangement 10 capable of ensuring a non-rigid connection between said bearing structure and said container, so as to interrupt (or at least significantly limit) the transmission of movement from said bearing structure to said carried load.

In the embodiment illustrated in FIGS. 1-3, said supporting arrangement 10 comprises a supporting frame 12, consisting of a plurality of longitudinal beams 14 and transverse beams 16.

Said longitudinal beams 14 and said transverse beams 16 will have a size such as to allow mounting the container 100 to the supporting frame 12.

For example, the longitudinal beams 14 and the transverse beams 16 will preferably have the same size as the lower longitudinal beams 104 and the lower transverse beams 106 of the container 100 (which, in turn, has standard dimensions determined by ISO standards), respectively. In this way, once the container 100 is arranged on the supporting frame 12 of the supporting arrangement 10, the points where said longitudinal beams 14 and said transverse beams 16 connect to each other will be aligned with the corner blocks 112 of the container 100.

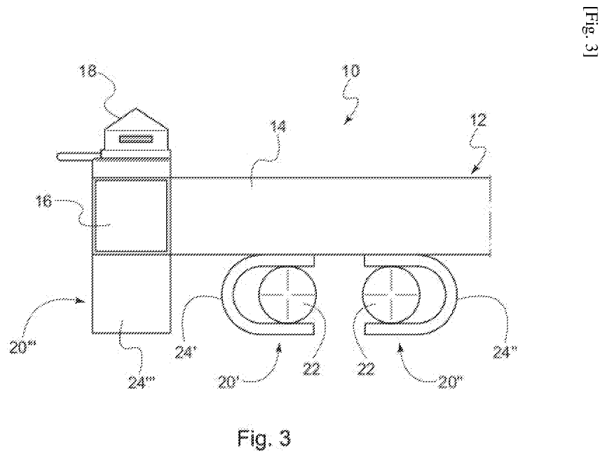

Accordingly, as visible in FIG. 3, the supporting frame 12, at said points where the longitudinal beams 14 and the transverse beams 16 connect to each other is provided with connecting means capable of cooperating with the connecting means of the corner blocks 112 of the container 100. Therefore, in the illustrated embodiment, the supporting frame 12, at said points where the longitudinal beams 14 and the transverse beams 16 connect to each other, is provided with male “twist-lock” connection elements 18.

The supporting arrangement 10 further comprises a plurality of movement dampers 20 arranged between the supporting frame 12 and the bearing structure integral with the ship: the upper portion of said movement dampers 20 is connected to the lower face of the supporting frame 12, whereas the lower portion of said movement dampers 20 is provided with connecting means for connection to the underlying bearing structure, said connecting means being preferably configured so as to cooperate with connecting means which are conventionally already provided on said bearing structure.

Thanks to this arrangement, the movement dampers 20 will perform both the function of connecting the load to the bearing structure and the function of interrupting the transmission of movement from the bearing structure to the load.

In general, each movement damper 20 preferably comprises a load-bearing component 22, adapted to bear the vertical loads generated by overlying loads as well as by the supporting frame, and a damping component 24, adapted to interrupt—or at least significantly limit—the transmission of movement from the bearing structure integral with the ship to the container.

The load-bearing component can be made as a body made of a substantially rigid material. In particular, in the preferred embodiment illustrated in FIGS. 1-3, the load-bearing component is made as a ball 22 made of a substantially rigid material.

The damping component is made as a plate 24 arranged around the load-bearing component and shaped so as to have a concave or convex portion, the concavity/convexity being oriented in a direction substantially perpendicular to the direction of load application.

In particular, in the embodiment illustrated in the Figures, the damping component is made as a “C”-shaped plate 24 and the top of the ball 22 is in contact with the upper arm of the “C”-shape of the plate 24, whereas the bottom of the ball 22 is in contact with the lower arm of the “C”-shape of said plate 24.

In any case, it will be evident to the person skilled in the art that the damping component may also have shapes other than the “C”-shape, provided that it comprises at least one concave or convex portion.

As better visible in FIG. 3, in order to damp the containers with respect to movements oriented in different direction, it is convenient to mount a plurality of movement dampers to the supporting frame 12 in such a way that their damping components are oriented in different directions.

In particular, in the illustrated embodiment, it will be possible to provide a first group of movement dampers 20′ with their respective “C”-shaped plates 24′ oriented in a certain direction, a second group of movement dampers 20″ with their “C”-shaped plates 24″ offset by 90° with respect to those of the movement dampers of the first group, a third group of movement dampers 20′″ with their “C”-shaped plates 24″′ offset by 90° with respect to those of the movement dampers of the second group (and thus by 180° with respect to those of the movement dampers of the first group) and a fourth group of movement dampers (not visible in the Figure) with their “C”-shaped plates offset by 90° with respect to those of the movement dampers of the third group.

It is evident that other solutions would also be possible. However, the solution shown in FIG. 3 makes it possible to arrange the movement dampers 20 with their corresponding “C”-shaped plates aligned with the longitudinal beams 14 or the transverse beams 16 of the supporting frame 12.

This configuration is clearly of advantage in that the movement dampers do no protrude from the supporting frame 12. In this way, on the one hand, they do not constitute any hindrance and, on the other hand, they are protected against impacts that could damage them.

It should be noted that, in a variant of the embodiment illustrated above, the supporting frame 12 might comprise, in addition to the movement dampers 20, vibration dampers acting in a direction perpendicular to said movement dampers.

In this case, vibration dampers might be provided on one or more sides of the supporting frame, and preferably on one or more pairs of opposite sides of said supporting frame: a first end of each vibration damper would be attached to said supporting frame, whereas the second, opposite side of each vibration damper would be attached to a structure integral with the ship.

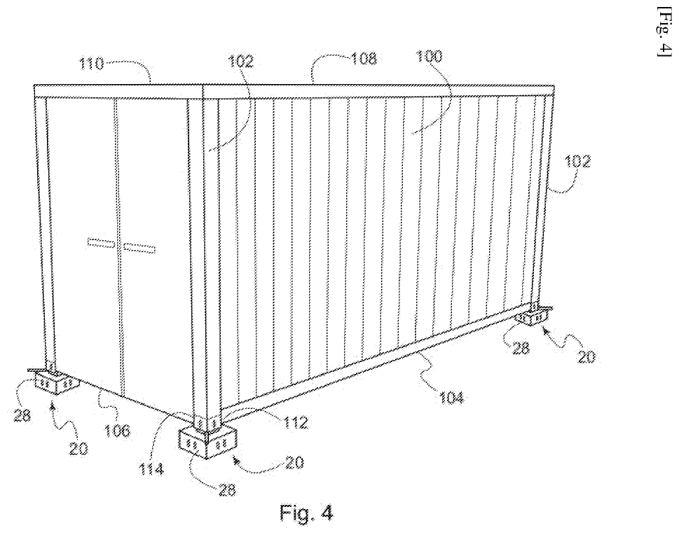

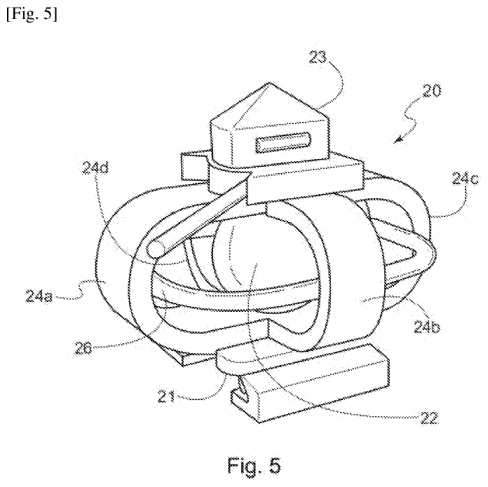

Turning now to FIGS. 4-5, there is illustrated a second embodiment of a supporting arrangement 10 for containers 100 according to the invention.

This second embodiment differs from the previously described embodiment in that no supporting frame is provided and the movement dampers 20 are directly interposed between the container 100 and the bearing structure integral with the ship.

The container 100 of FIG. 4 has the same structure as the container of FIG. 1 and will not be described again in detail. It should be pointed out that in this case, too, the container 100 is provided with corner blocks 112 having connecting means, in particular respective female “twist-lock” connection elements 114.

Correspondingly, the supporting arrangement 10 will comprise the same number of movement dampers 120 as the number of corner blocks 112 of the container 100 (typically, four).

In this embodiment, too, the lower portion of each movement damper 20 will be provided with connecting means 21 for connection to the underlying bearing structure. However, in this embodiment, it is the upper portion of each movement damper 20 that will be provided with connecting means adapted to cooperate with the connecting means provided on the corner blocks 112 of the container 100, i.e. in this case with a male “twist-lock” connection element 23.

As in the former embodiment, each movement damper 20 comprises a load-bearing component, adapted to bear the vertical loads generated by overlying containers, and a damping component, adapted to interrupt—or at least significantly limit—the transmission of movement from the bearing structure integral with the ship to the containers, and the load-bearing component is made as a ball 22 made of a substantially rigid material.

However, in this embodiment, in order to damp the containers with respect to movements oriented in different directions, the damping component of each movement damper 20 is made as a plurality of plates 24a, 24b, 24c, 24d arranged around the ball 22 and oriented in different directions.

In this case, too, the plates 24a, 24b, 24c, 24d will be shaped so as to comprise a concave or convex portion, the concavity/convexity being oriented in a direction substantially perpendicular to the direction of load application.

For example, the plates 24a, 24b, 24c, 24d will be “C”-shaped plates, although other shapes are possible.

Preferably, said “C”-shaped plates are evenly distributed around the ball 22. For example, in FIG. 5 the movement damper 20 comprises four “C”-shaped plates 24a, 24b, 24c, 24d arranged at 90° relative to one another.

Advantageously, according to this embodiment, each movement damper 20 taken individually is capable of effectively damping movements oriented in different directions.

As can be seen in FIG. 5, it is also possible to provide a reinforcement element 26, having a substantially annular shape, which is arranged around the “C”-shaped plates 24a, 24b, 24c, 24d, at their concave portions, and helps preventing possible deformations thereof.

Finally, as can be seen in FIG. 4, it is possible to provide that each movement damper 20 be provided with an outer protective casing 28, in which the load-bearing component and the damping component are housed.

It will be evident to the person skilled in the art that the detailed description above has been provided merely by way of example and that several variations and modifications can be made thereto, while still falling within the scope of protection defined by the appended claims.

1. A supporting arrangement for supporting a carried load carried on a ship, the carried load being arranged on a bearing structure integral with the ship, wherein the supporting arrangement comprises a plurality of movement dampers interposed between said carried load and said bearing structure integral with the ship.

2. The supporting arrangement according to claim 1, wherein each of the movement dampers comprises a load-bearing component, adapted to bear the vertical loads generated by the carried load, and a damping component, adapted to interrupt or significantly limit the transmission of movement from the bearing structure integral with the ship to the carried load.

3. The supporting arrangement according to claim 2, wherein the load-bearing component is made as a body made of a substantially rigid material.

4. The supporting arrangement according to claim 3, wherein the load-bearing component is made as a ball (22) made of a substantially rigid material.

5. The supporting arrangement according to claim 2, wherein the damping component is made as a plate arranged around the load-bearing component and shaped so as to comprise a concave or convex portion.

6. The supporting arrangement according to claim 5, comprising a plurality of groups of movement dampers, the concave or convex portion of the plates of the movement dampers of each group of movement dampers being oriented in a different direction relative to the concave or convex portion of the plates of the movement dampers of the other groups of movement dampers.

7. The supporting arrangement according to claim 2, wherein the damping component is made as a plurality of plates arranged around the load-bearing component and with a different orientation, each of said plates being shaped so as to comprise a concave or convex portion.

8. The supporting arrangement according to claim 1, wherein the movement dampers are directly interposed between the carried load and the bearing structure integral with the ship, wherein the lower portion of each of the movement dampers is provided with connecting means for connection to the bearing structure integral with the ship, and wherein the upper portion of each of the movement dampers is provided with connecting means adapted to cooperate with connecting means provided on the carried load.

9. The supporting arrangement according to claim 8, wherein the upper portion of each of the movement dampers is provided with a male “twist-lock” connecting element.

10. The supporting arrangement according to claim 1, wherein the supporting arrangement further comprises a supporting frame, wherein the upper face of the supporting frame is provided with connecting means adapted to cooperate with connecting means provided on the carried load, and wherein the movement dampers are applied to the lower face of the supporting frame.

11. The supporting arrangement according to claim 10, wherein the upper face of the supporting frame is provided with a plurality of male “twist-lock” connecting elements.

12. The supporting arrangement according to claim 1, wherein the carried load comprises a plurality of containers arranged in superimposed stacks on the bearing structure integral with the ship, and wherein the movement dampers are interposed between the containers of a lowermost row of the superimposed stacks of containers and the bearing structure integral with the ship.
